(19) United States
(12) Patent Application Publication
(10) Pub. No.: US 2013/0045782 A1
(43) Pub. Date: Feb. 21, 2013

(54) ELECTRONIC DEVICE CASE WITH SOUND ENHANCEMENT PORTS

(71) Applicant: Garrett Paul SIMMER, Atlanta, GA (US)

(72) Inventor: Garrett Paul SIMMER, Atlanta, GA (US)

(73) Assignee: CASE-MATE, INC., Tucker, GA (US)

(21) Appl. No.: 13/570,615

(22) Filed: Aug. 9, 2012

Related U.S. Application Data
(60) Provisional application No. 61/524,868, filed on Aug. 18, 2011.

(51) Int. Cl. H04W 88/02; B23P 11/00

(52) U.S. Cl. 455/575.8; 29/428

(57) ABSTRACT

A case for an electronic device comprises one or more sound enhancement ports. The sound enhancement ports comprise a first opening oriented in a first direction, a second opening oriented in a second direction generally perpendicular or unaligned with the first direction, and a sound conduit between the first and second openings. An electronic device is inserted into the case and the sound enhancement ports are positioned to provide passive amplification or directional enhancement to sound waves.

### CROSS-REFERENCE TO RELATED APPLICATION

This application claims the benefit of U.S. Provisional Patent Application Ser. No. 61/524,868, filed Aug. 18, 2011, the entirety of which is hereby incorporated herein by reference.

### TECHNICAL FIELD

The present invention relates generally to the field of electronic device cases, and more particularly to cases for phones, tablet devices and other electronic devices.

### BACKGROUND

Many electronic communication devices allow users to communicate with other users via a communications network or service. An example of such a device is a cellular telephone, which many people use to vocally communicate with others in different locations. Cellular telephones are often used by placing the telephone's speaker by the user's ear and positioning the telephone's microphone by the user's mouth. The user speaks into the microphone and received audio is transmitted through the speaker. The use of advanced cellular telephones or “smart phones” is increasing more and more in the cellular telephone market. Advanced cellular telephones are often expensive and users often want to protect the condition of their device in a case or housing.

Cellular telephone devices and other electronic devices are sometimes designed with a “speaker” or “hands-free” function that allows the user to carry on a conversation without having to place the telephone by his/her ear. The “speaker” function can be advantageous for hands-free communication. However, depending on the positioning and orientation of the telephone, the telephone's speaker and the microphone can become blocked when a protective case or cover is installed on the telephone, negatively affecting the audio quality provided. Also, even if a case is not used with a telephone, the speaker or microphone ports can become blocked if the telephone is positioned against a surface, for example if a telephone with a microphone port on its bottom edge is set upright with its bottom edge supported on a table or desk.

Similarly, electronic devices such as tablet computers, MP3 players, audio players, video players and game devices may have sound outputs that can be obstructed or that otherwise do not direct sound optimally toward a user in certain orientations or modes of operation.

Accordingly, it can be seen that needs exist for improving or enhancing the audio performance of an electronic device during operation. It is to the provision of a protective case for an electronic device meeting these and other needs that the present invention is primarily directed.

### SUMMARY

In example embodiments, the present invention provides a protective case or housing for an electronic device such as a smart phone, which includes sound-directing or enhancing ports or channels for improving audio quality. One or more such sound-enhancing ports can be provided, for example an audio input port for directing external sounds inwardly toward the electronic device's microphone, and an audio outlet port for directing sound from the electronic device's speaker outwardly toward a user.

In one aspect, the present invention relates to a case for housing an electronic device therein. The case includes at least one sound-directing port having a first opening, a second opening, and a sound channel extending between the first and second opening. The first opening is configured for alignment with a sound element such as a microphone or speaker of an electronic device onto which the case is installed, and the second opening is directed away from the electronic device.

In another aspect, the invention relates to a case for housing an electronic device that includes at least one sound element. The case includes at least one sound-enhancing port having a sound channel for a sound wave travelling with respect to the electronic device. The sound channel includes a first aperture and a second aperture positioned at an angle of inclination with respect to each other.

In another aspect, the invention relates to a method of enhancing sound delivery to or from an electronic device having a sound element such as a microphone or speaker. The method includes mounting a case to the electronic device, the case having at least one sound-directing port having a first opening configured for proximity to the sound element of the electronic device and a second opening directed away from the sound element of the electronic device.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a front view of a protective case with sound enhancement ports for an electronic device according to an example embodiment of the invention.

FIG. 2 is a first side view of the electronic device case of FIG. 1.

FIG. 3 is a second side view of the electronic device case of FIG. 1.

FIG. 4 is a top view of the electronic device case of FIG. 1.

FIG. 5 is a bottom view of the electronic device case of FIG. 1.

FIG. 6 is a rear view of the electronic device case of FIG. 1.

FIG. 7 is another side view of the electronic device case of FIG. 1.

FIG. 8 is a cross sectional view of the electronic device case of FIG. 7.

FIG. 9 is a perspective section view showing an example form of the sound enhancement ports in greater detail.

FIG. 10 is a perspective cutaway view of one of the sound enhancement ports of FIG. 9.

FIG. 11 is a front view of the electronic device case of FIG. 1 shown installed onto an electronic device in example form.

FIG. 12 is a rear view of the electronic device case with an electronic device installed as shown in FIG. 11.

FIG. 13 is a front view of an electronic device case with decorative features according to a further example embodiment.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

On some electronic devices, the sound waves emitted from the device's speaker usually emit outwards from an edge of the device. Likewise, sound waves that are travelling towards the device's microphone are best received by the microphone when the origin of the sound wave is facing or adjacent to the edge of the device. When the orientation of the device is positioned such that the speaker and microphone are generally blocked by a support surface or other object, sound may be muffled or blocked. The case 10 of the present invention is applied onto an electronic device to direct sound waves emitting from the speaker forward and to enable sound waves directed towards the front of the phone to be registered by the microphone.

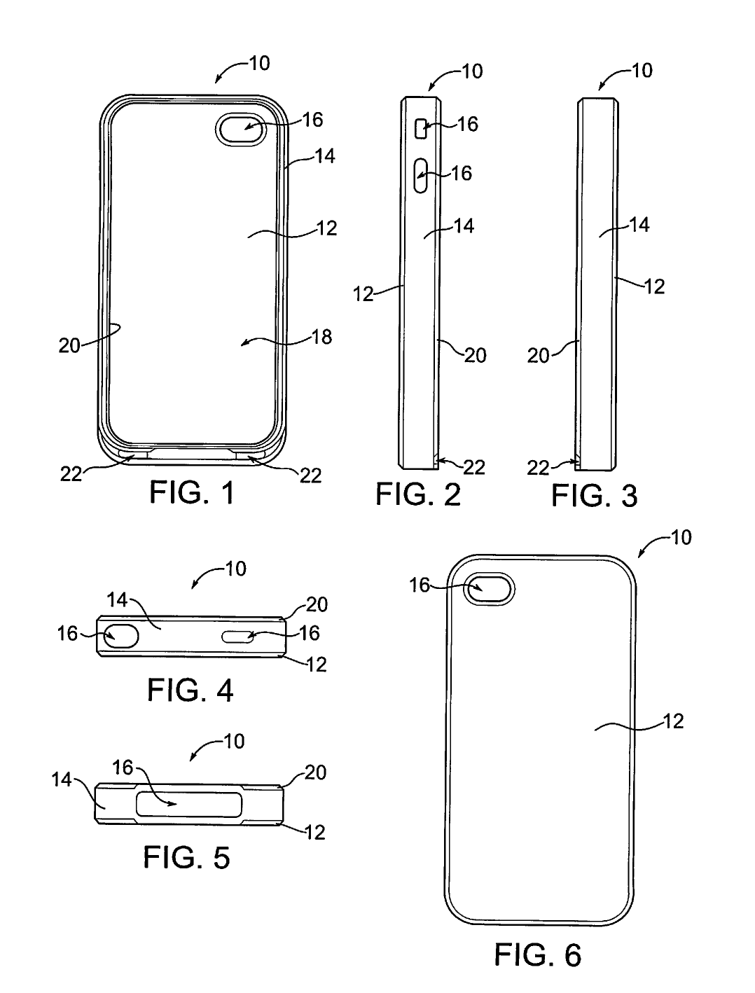

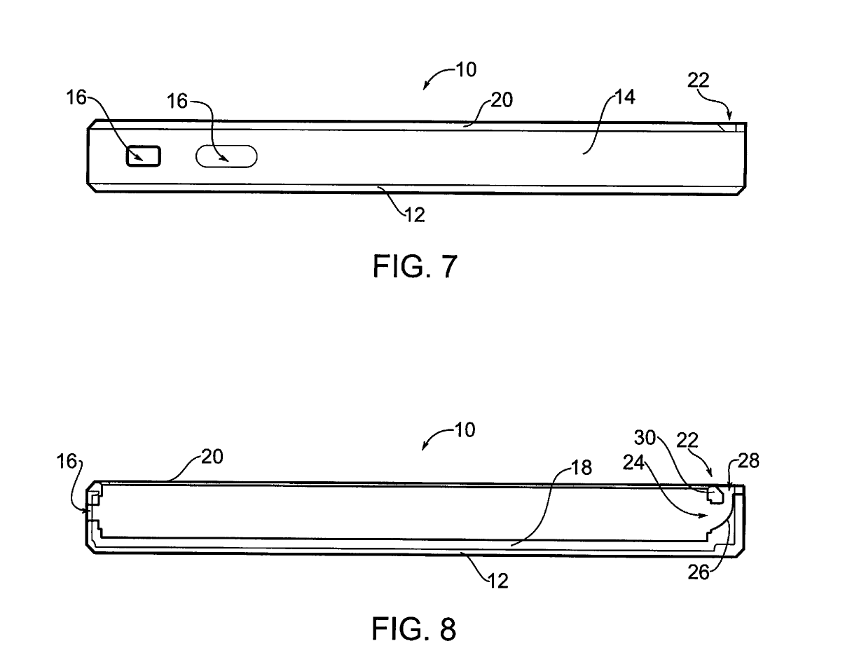

With reference now to the drawing figures, wherein like reference numbers represent corresponding parts throughout the several views, FIGS. 1-12 show an electronic device case 10 according to an example embodiment of the present invention. The case 10 includes a back panel or base 12 and a raised side wall 14 extending around the periphery of the base 12. In the depicted embodiment, the base 12 is generally flat and rectangular with rounded corners, but in alternate embodiments the base can have different configurations to match the shape of a particular electronic device. The sidewall 14 has a free distal edge and a proximal edge secured around the perimeter of the base 12 The distal edge of the sidewall 14 projects transversely outward from the periphery of the base 12, forming a shallow rectangular tray configuration. In the depicted embodiment, a single continuous sidewall 14 includes four radiused corners bounding an interior chamber for receiving the electronic device. In alternate embodiments, two or more separate sidewall sections can extend from discrete sections of the base periphery.

The base 12 and sidewall 14 optionally have one or more apertures 16 extending therethrough. The apertures 16 are positioned to align with buttons, switches, ports, camera lenses, touch-screen(s) or other user interfaces or mechanisms on an electronic device that is inserted into the case 10. In example forms, the base 12 and wall 14 are constructed of a unitary molding of substantially rigid and impact-resistant polymeric material.

The depicted case 10 optionally includes an inner layer 18, for example a liner, that conforms to the inner surface of the shallow tray configuration formed by the base 12 and the side wall 14. The inner layer 18 preferably includes a resilient or compressible material such as silicon, rubber, elastomer or the like, to cushion a secured electronic device from unplanned impacts. As depicted, the inner layer 18 includes a ridge or flange 20 extending inwardly from the sidewall 14 towards the center of the case 10. Preferably, the ridge or flange 20 extends inwardly at a defined angle with respect to the sidewall 14. More preferably, the ridge or flange 20 extends from the free edge of the sidewall 14 in order to retain the case 10 in place on a secured electronic device.

The depicted case 10 defines one or more sound enhancement ports 22 for directing sound to and/or from a secured electronic device. In the depicted embodiment, two sound enhancement ports 22 are located near at least one sidewall 14 edge of the case 10. Preferably, when an electronic device is secured within the case 10, the sound enhancement ports 22 align with the bottom, or microphone, end of the device. FIG. 8 shows a cross sectional view of the case 10 with the sectional plane passing through one of the sound enhancement ports 22. In this particular embodiment, the sound enhancement port 22 has an elbow shaped cross sectional profile with a smooth radius defining approximately a 90° bend. However, one of ordinary skill in the art can envision alternative dimensions.

As depicted, each port 22 has a first opening 24 and a second opening 28 connected by a channel or sound conduit 26. The first opening 24 has a periphery generally aligned with a plane parallel to the sidewall 14 of the case, and the second opening 28 has a periphery generally aligned with a plane parallel to the back panel 12 of the case. The first opening 24 is inwardly-offset from the interior surface of the inner layer 18 and the lower or other external edge of the case 10 in a position to align with a speaker and/or microphone component of the electronic device to be installed therein. The second opening 28 is positioned at or toward the distal edge of the sidewall 14, opposite the back panel 12.

The channel 26 is generally elbow shaped and tapers from the first opening 24 to the second opening 28. The interior surfaces of the channel 26 are preferably smooth and regular, and formed of a material having good sound-reflective properties. As depicted, the ridge 20 of the inner layer 18 forms a bridge 30 of material that extends across the second opening 28 to provide a definition between the first 24 and second opening.

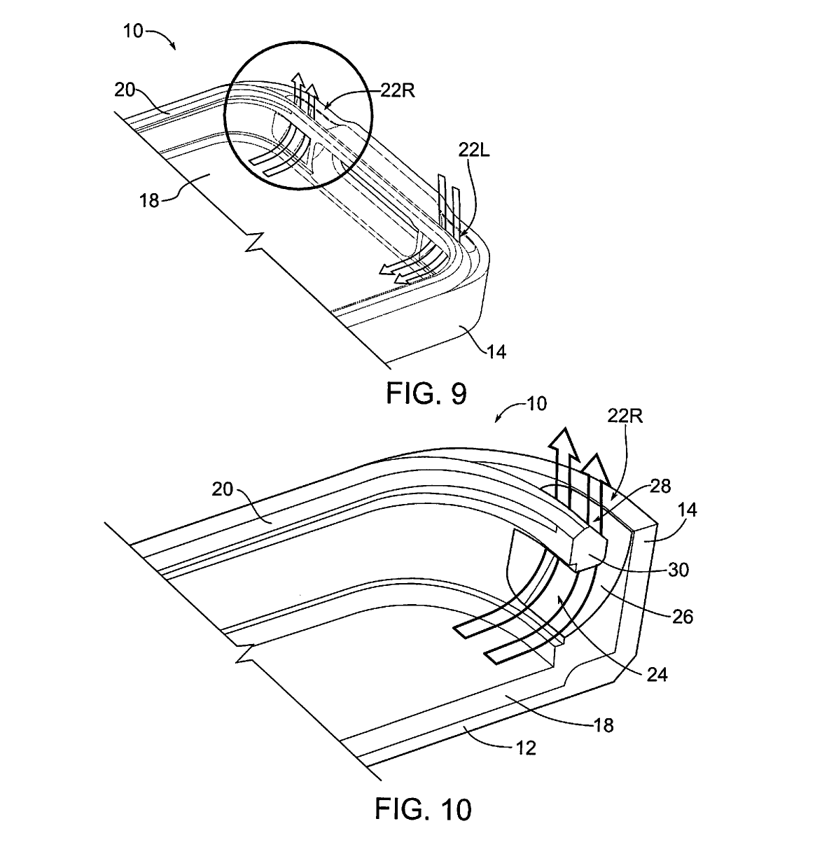

As depicted in FIGS. 9-10, each sound port 22 has a sound inlet and a sound outlet that are angularly-oriented with respect to one another. In the depicted embodiment, the inlet and outlet faces of the sound ports are oriented at about 90° with respect to one another, but in alternate embodiments greater or lesser angles of orientation are provided, for example from about 30° to about 150°. In operation, the sound ports 22 allow for sound waves that pass through to be passively amplified as they travel between the first opening 24 to the second opening 28 and vice versa.

In an example method of use, an electronic device is installed within the case 10, with the device's exterior housing fitting snugly within the inner layer 18 and the raised wall 14 and held therein by a friction fit with the inner layer 18. The ridge 20 can include a resilient lip projects inwardly over the front surface of the electronic device about its periphery, helping to retain the device within the case 10.

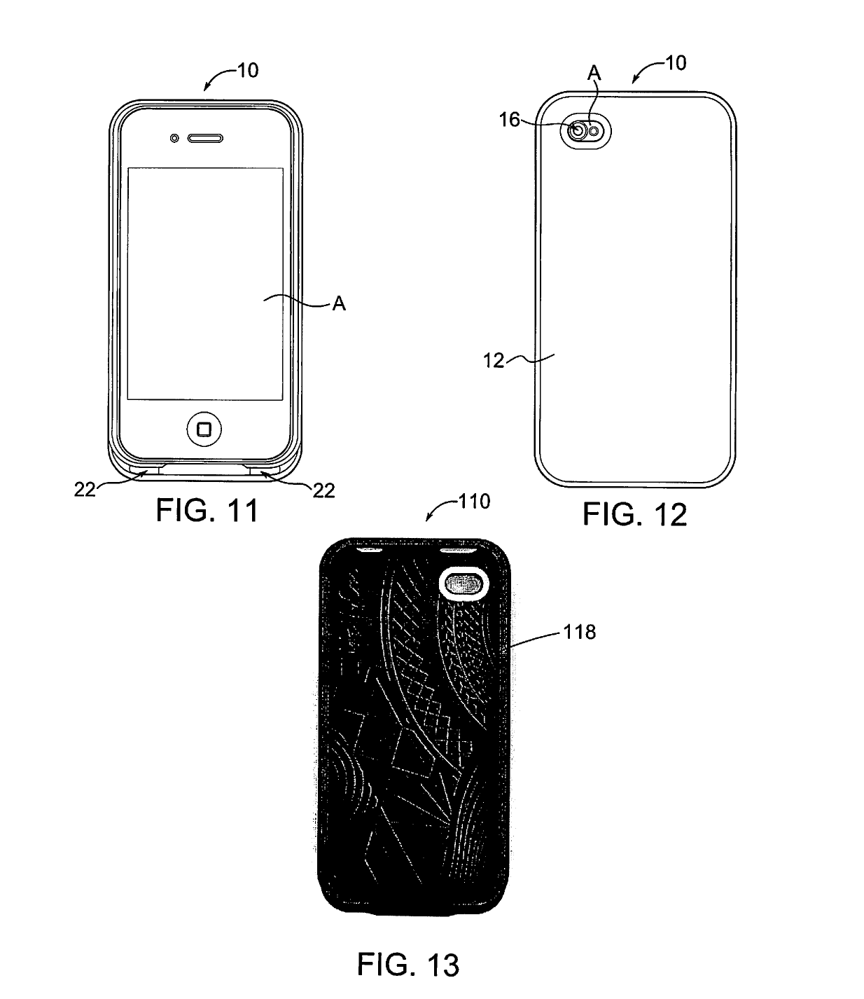

The speaker and microphone are aligned with a respective one of the sound enhancement ports 22 when the case 10 is installed onto the electronic device, so that the speaker and microphone are located in proximity to the respective first opening 24. In the depicted embodiment of FIGS. 11 and 12, the electronic device A is a cellular telephone with a speaker and a microphone located on its bottom edge, for example an APPLE IPHONE4. The speaker and microphone of the IPHONE4 are located on the bottom surface of the device, placed in proximity to the sound enhancement ports 22 as depicted. The sound waves that enter and exit the sound enhancement port 22L are amplified and/or enhanced such that sound waves entering the microphone are better received; and the sound waves emitted by the speaker are amplified and/or enhanced as they leave the sound enhancement port 22R.

It should be noted that the case 10 could be designed and constructed to fit virtually any electronic device. Depending on the location on a particular alternative electronic device, the sound enhancement ports 22 can be relocated on the case 10 to align with the speaker and microphone, and/or a single sound port may be in communication with both the speaker and the microphone. In the depicted embodiment of FIGS. 9-10, a left sound enhancement port 22L serves the microphone and the right sound enhancement port 22R serves the speaker. In alternate embodiments, the positions may be reversed or otherwise configured.

As seen schematically in FIGS. 9 and 10, sound waves (indicated by the arrows) can travel through the sound enhancement ports 22. The sound enhancement ports 22 amplify, focus, and direct the sound waves that travel through either of their openings. During example operation, the sound waves enter the left sound enhancement port 22L through the second opening and sound conduit and exit through the respective first opening toward the secured device's microphone. Sound waves emitted by the secured device's speaker enter the right sound enhancement port 22R through its first opening 24, travel through the sound conduit 26, and exit through its respective second opening 28. Alternatively, sound waves traveling toward, and away from, a secured electronic device microphone or speaker can travel through a single sound enhancement port.

The sound waves travelling through either sound enhancement port 22 can passively increase in decibel (dB) sound pressure level (SPL) due to the shape and contour of the tunnels 26 of the ports 22. In some experiments, the sound enhancement for the electronic device has been determined to be about +4 dB SPL. In other embodiments, the sound enhancement can be greater or less, depending on the design and construction of the sound enhancement ports. It has been determined that speakers generally have an optimally-sized cavity volume where the optimum dB SPL is achieved. Depending on the design of the sound enhancement ports 22, a greater cavity volume can be used by the speaker to achieve an optimal dB SPL. In alternate forms of the invention, the sound ports redirect the sound waves without amplification for enhanced performance, such as for example when a telephone is used in speaker mode with its side or edge containing the speaker and/or microphone resting on a support surface.

FIG. 13 shows an electronic device case 110 according to a further example embodiment of the present invention. The case 110 is substantially similar to the case 10. The case 110 has an inner layer 118 that has a decorative design imprinted, molded, or embossed on its inner surface.

While the invention has been described with reference to preferred and example embodiments, it will be understood by those skilled in the art that a variety of modifications, additions and deletions are within the scope of the invention, as defined by the following claims.

What is claimed is:

1. A case for housing an electronic device comprising at least one sound element, said case comprising:
at least one sound-enhancing port comprising a sound channel for a sound wave travelling with respect to the electronic device, the at least one sound-enhancing port configured to align with at least one electronic device sound element.

2. The case of claim 1, wherein the sound channel comprises a first aperture at a first end and a second aperture at a second end.

3. The case of claim 2, wherein the first aperture and the second aperture are positioned at an angle of inclination with respect to each other

4. The case of claim 3, wherein the angle of inclination is between about 30° to about 150°.

5. The case of claim 3, wherein the angle of inclination is about 90°.

6. The case of claim 2, wherein the first aperture is configured to align with the at least electronic device sound element and the second aperture is configured to be directed away from the electronic device.

7. The case of claim 1, further comprising a tray for engaging an outer surface of the electronic device.

8. The case of claim 7, wherein the tray comprises a bridge extending across the at least one sound-enhancing port.

9. The case of claim 1, comprising a base panel and at least one sidewall panel projecting transversely from the base panel and bounding an interior chamber for receiving the electronic device.

10. The case of claim 9, wherein the base panel and/or the sidewall panel define at least one opening therethrough for accessing a feature of the electronic device.

11. A case for housing an electronic device comprising at least one sound element, said case comprising:
at least one sound-enhancing port comprising a sound channel for a sound wave travelling with respect to the electronic device, the sound channel comprising a first aperture and a second aperture positioned at an angle of inclination with respect to each other.

12. The case of claim 11, wherein the angle of inclination is between about 30° to about 150°.

13. The case of claim 11, wherein the angle of inclination is about 90°.

14. The case of claim 11, further comprising a tray for engaging an outer surface of the electronic device.

15. The case of claim 14, wherein the tray comprises a bridge extending across the at least one sound-enhancing port.

16. The case of claim 14, further comprising a resilient liner conforming within the tray.

17. The case of claim 16, wherein the resilient liner defines a bridge extending across the at least one sound-enhancing port.

18. The case of claim 11, wherein the at least one sound-enhancing port is designed to align with the at least one electronic device sound element.

19. A method of enhancing sound delivery to or from an electronic device having a sound element, the method comprising:
mounting a case to the electronic device, the case comprising at least one sound-directing port comprising a first opening configured for proximity to the sound element of the electronic device and a second opening directed away from the sound element of the electronic device.

20. The method of claim 19, further comprising passively amplifying a sound wave that passes through the sound-directing port.
